(19) United States
(12) Patent Application Publication
(10) Pub. No.: US 2006/0261604 A1
(43) Pub. Date: Nov. 23, 2006

(54) Fastening mechanism

(75) Inventors: Yun-Jie Ya, Taipei (TW); Yi-Shan Li, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/130,204

(22) Filed: May 17, 2005

(51) Int. Cl. E05C 3/04

(52) U.S. Cl. 292/218

(57) ABSTRACT

A fastening mechanism includes an anchor hole, a latch plate, a latch member and a pin. The fastening member runs through the anchor hole formed on a body and the latch plate of a case. The latch member has a pin on a distal end to clamp the latch plate so that the case receives a force and is confined and fastened. Assembly and disassembly of the case can thus be accomplished without using screws.

### FIELD OF THE INVENTION

The invention relates to a fastening mechanism, and particularly to a fastening mechanism that does not require screws.

### BACKGROUND OF THE INVENTION

With the rapid advance of information technology, wide varieties of electronic devices have been developed and have become indispensable to people in their daily lives.

A conventional electronic device usually has a host case which consists of a plurality of panels (such as a front face panel, a rear panel, a upper lid, a lower lid and two side panels) latched on or fastened to a frame. Fastening is usually accomplished by screwing the panels on the frame with a plurality of screws.

Refer to FIG. 1 for assembly of a conventional side panel. First, a side panel 10 is temporarily held on an anchored position by wedging hooks formed thereon in coupling apertures 25 formed on a frame 20. Screws 30 are then used to run through fastening holes 15 on the side panel 10 to engage with screw holes on a rear panel 40 and the frame 20 to fasten the side panel on the frame 20.

The fastening method for such a side panel requires several screws and a tool for assembly and disassembly, which is inconvenient. Moreover, the side panel has to be removed by unfastening the screws from the rear panel. In the event that the screws are lost during assembly and disassembly, a short circuit could happen to the host and result in hazardous conditions. Moreover, the assembly and disassembly processes mentioned above are time-consuming and not competitive in the present market environment.

On the other hand, the screw-free fastening mechanisms now being adopted mostly are used on data storage devices. When removing data storage devices, the case has to be removed first. Hence to develop a fastening mechanism that can reduce assembly and disassembly procedures without using tools is needed to improve production and maintenance efficiency and enhance competitiveness.

### SUMMARY OF THE INVENTION

In view of the aforesaid problems, the primary object of the invention is to provide a fastening mechanism to enable machine cases to be assembled and disassembled rapidly without using tools.

The fastening mechanism according to the invention mainly includes an anchor hole, a latch plate, a latch member and a pin. The anchor hole is formed on a body (such as a frame) of a case. The latch plate is located on the case corresponding to the anchor hole, and has a retaining aperture. The latch member has a turning section and a stem extended from one end of the turning section. The stem has a through hole on a distal end.

The turning section is larger than the anchor hole, while the stem has a diameter smaller than the anchor hole and the retaining aperture. The pin may run through the through hole and is turnable with the turning section.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional assembly condition for a side panel.

FIG. 2 is an exploded view of the fastening mechanism of the invention.

FIG. 3A is a bottom view of the invention in a latch condition.

FIG. 3B is a top view of the invention in a latch condition.

FIG. 4A is a bottom view of the invention in an unlatch condition.

FIG. 4B is a top view of the invention in an unlatch condition.

FIG. 5A is a schematic view of the invention in a first positioning condition for assembly.

FIG. 5B is a schematic view of the invention in a second positioning condition after finished assembly.

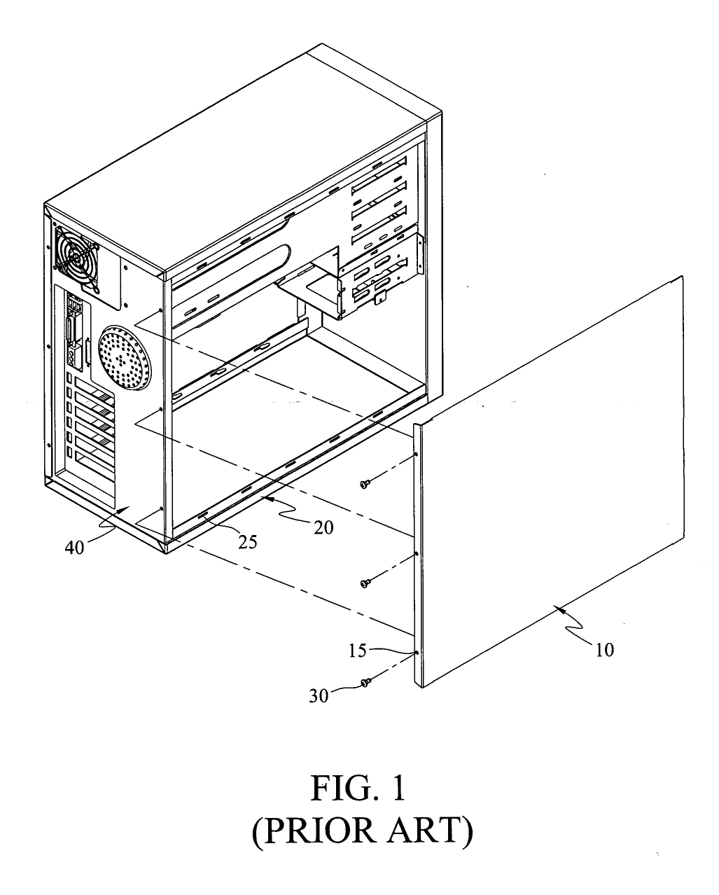

### DESCRIPTION OF THE PREFERRED EMBODIMENTS

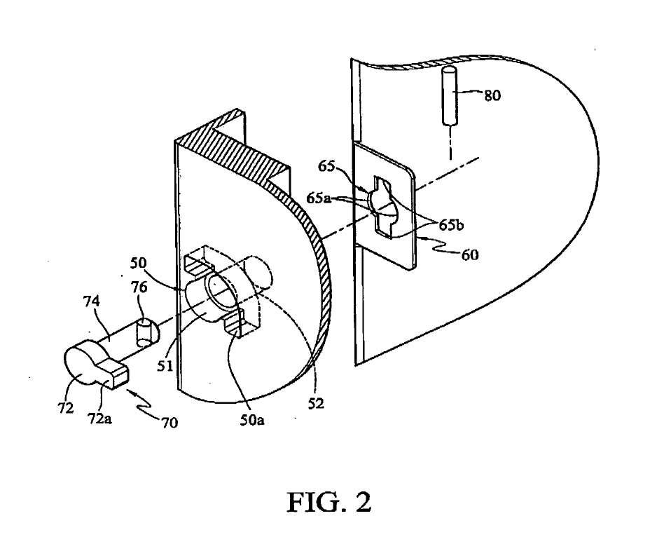

Refer to FIG. 2 for the exploded view of the fastening mechanism of the invention. The invention includes an anchor hole 50, a latch plate 60, a latch member 70 and a pin 80.

The anchor hole 50 is selectively formed on a body (not shown in the drawing). The number of the anchor holes 50 may be one or more according to requirements. It has a sliding trough 50a on an outer side with one edge marked by a lock position and another edge marked by an unlock position. The body is the frame of an electronic device or a frame containing a front panel (face panel).

The latch plate 60 has a retaining aperture 65 formed thereon. The retaining aperture 65 has two opposite sides of different lengths (a latch side 65a and an unlatch side 65b). The latch side 65a is slightly shorter than the pin 80. The unlatch side 65b is longer than the pin 80.

The latch plate 60 corresponds to the anchor hole 50, and may be formed on the case integrally, or by stamping, soldering or riveting. The case may be a single side panel that includes an upper lid and a lower lid and two side panels, an upper lid and a side panel, or a lower lid and a single side panel.

The latch member 70 includes a turning section 72 and a stem 74, which is extended from one end of the turning section 72. The stem 74 has a through hole 76 on a distal end to receive a pin 80 so that the pin 80 may be turned with the turning section 72.

The turning section 72 is formed to a dimension greater than the anchor hole 50. It has a lug 72a to indicate the latch position and the unlatch position. The lug 72a is movable in the sliding trough. The diameter of the stem 74 is smaller than the anchor hole 50 and the retaining aperture 65. The stem 74 is formed to a length which can pass through the anchor hole 50 and the retaining aperture 65 so that the pin 80 may be coupled with the through hole 76 at the distal end thereof.

By means of the aforesaid construction, when the stem 74 passes through the anchor hole 50 and the retaining aperture 65, the turning section 72 is stopped outside the anchor hole 50 due to its larger size. When the turning section 72 is turned, the pin 80 also is driven and turned.

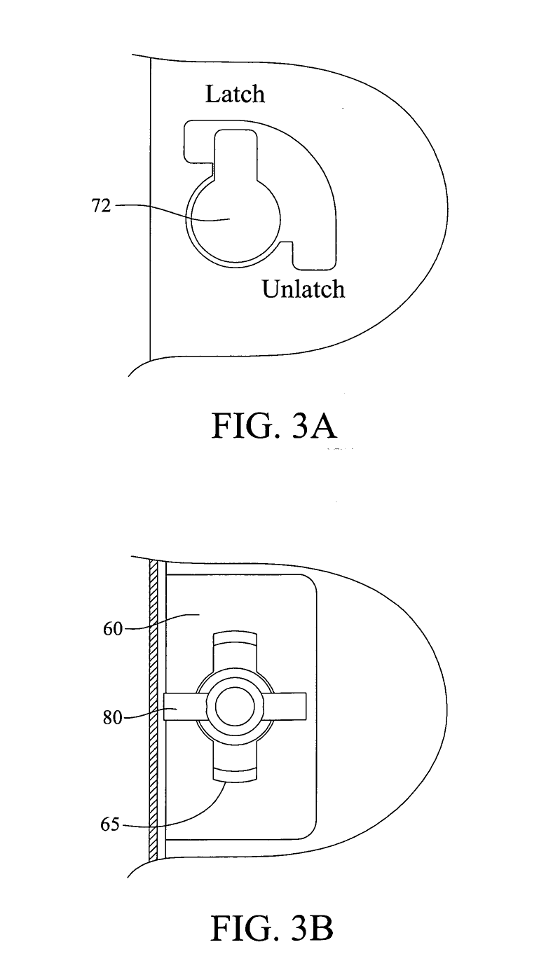

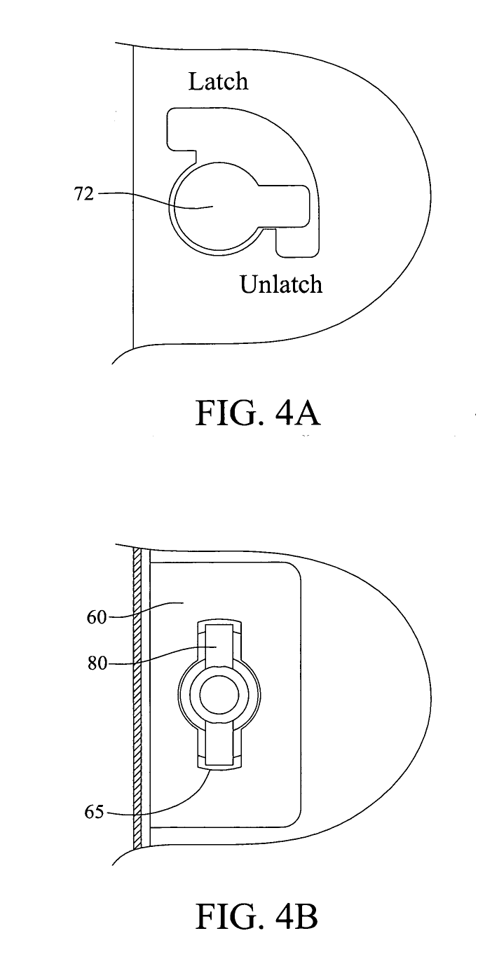

The stem 74 also may be directed by a barrel (not shown in the drawing) extended from one end of the latch plate 60 close to the latch plate 60 to pass through the latch plate 60. The latch member 70, latch plate 60 and pin 80 may be made from materials with sufficient harness and strength without restrictions, such as resins or metals. Refer to FIGS. 3A and 3B for the invention in a latch condition, and FIGS. 4A and 4B in an unlatch condition.

As shown in FIGS. 3A and 3B, when the turning section 72 is turned to the latch position marked on the outer side of the anchor hole 50, the pin 80 is turned to the latch position to clamp the latch plate 60 (on the latch side of the retaining aperture 65) so that the case also is latched and confined.

Referring to FIGS. 4A and 4B, when the turning section 72 is turned to the unlatch position, the pin 80 also is turned to unlatch the latch plate 60 (on the unlatch side of the retaining aperture 65) so that the case is unlatched and may be removed.

By means of the latch mechanism of the invention mentioned above, the case and the body may be coupled temporarily. Then they may be fastened through the fastening mechanism of the invention.

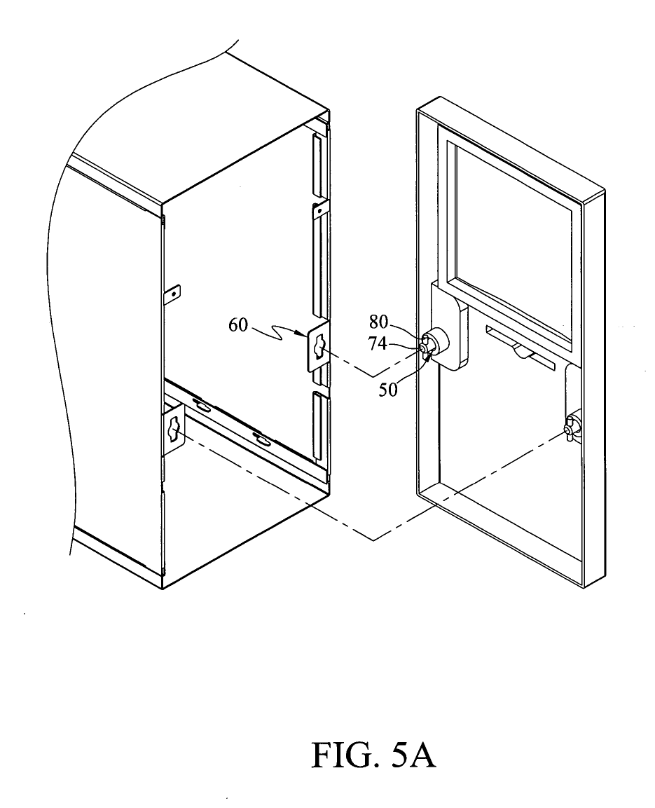

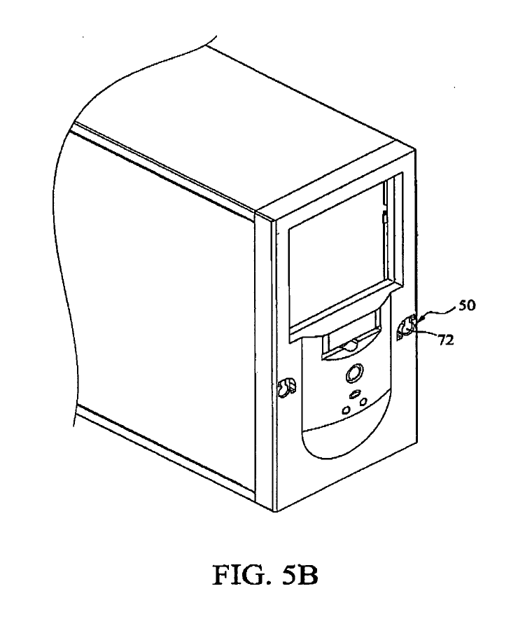

Refer to FIGS. 5A and 5B for the invention in use. FIG. 5A illustrates a first positioning condition of the fastening mechanism for fastening two side panels. FIG. 5B shows a second positioning condition of the fastening mechanism after the side panels have been fastened.

Referring to FIG. 5A, the anchor hole 50 is located on a front panel, the latch member 70 may be run though the anchor hole 50 before the pin 80 is inserted, and the latch member 70 equipped with the pin 80 may be run through the latch plate 60 to fasten the side plate (case).

Referring to FIG. 5B, as the anchor hole 50 is located on the front panel, assembly and disassembly of the case may be performed on the front end of the case much more readily. In practice, forming the anchor hole 50 on the front panel is not a limitation. The anchor hole may be located in any desired location as long as it is on the body and corresponds to the latch plate.

By means of the construction set forth above, the fastening mechanism can function without tools, and is not limited to assembly and disassembly of the rear panel. Assembly and disassembly operations are thus more convenient. Screws may be dispensed with to prevent short circuits from occurring to the host.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. (canceled)

2. (canceled)

3. The fastening mechanism of a front panel and a side panel of a computer case as claimed in claim 7, wherein the anchor hole has end extended to form a barrel to the latch plate to guide the stem to pass through the anchor hole and the retaining aperture.

4. The fastening mechanism of a front panel and a side panel of a computer case as claimed in claim 7, wherein the latch plate is selectively formed on the side panel integrally, or by stamping, soldering or riveting.

5. The fastening mechanism of a front panel and a side panel of a computer case as claimed in claim 7, wherein the state of the latching and the state of unlatching are marked on two ends of an outer side of the anchor hole.

6. (canceled)

7. A fastening mechanism of a front panel and a side panel of a computer case, comprising:
a front panel having an anchor hole, the anchor hole having a first end and a second end;
a side panel having a latch plate corresponding to the anchor hole, the latch plate having a retaining aperture including a latch side and an unlatch side, a diameter of the unlatch side being larger than that of the latch side, wherein the latch plate is connected on the side panel with an angle of 90 degrees;
a latch member having a turning section, a stem and a lug, the turning section being extended from the turning section and end of the turning section having a through hole, a diameter of the turning section being larger than that of the anchor hole, the stem passing through and the anchor hole and the retaining aperture and being rotated therein; and
a pin inserting in the through hold, a size of the pin being larger an that of the latch side and being smaller than that of the unlatch side, the pin being driven and turned by the turning section, wherein when the pin corresponding to the latch side, the front panel and the side panel being in a state of latching, when the pin corresponding to the unlatch side, the front panel and the side panel being in a state of unlatching.

8. The fastening mechanism of a front panel and a side panel of a computer case as claimed in claim 7, wherein diameter of the first end of the anchor hole is larger than that of the second end of the anchor hole.

9. The fastening mechanism of a front panel and a side panel of a computer case as claimed in claim 8, wherein the diameter of the first end of the anchor is larger than that of the turning section for accommodating the turning section.

10. The fastening mechanism of a front panel and a side panel of a computer case as claimed in claim 7, wherein the first end of the anchor hole has a sliding through.

11. The fastening mechanism of a front panel and a side panel of a computer case as claimed in claim 7, wherein the lug is used for indicating the state of latching and the state of unlatching.
